(19) United States
(12) Patent Application Publication
(10) Pub. No.: US 2026/0035285 A1
(43) Pub. Date: Feb. 5, 2026

(54) FURNACE DESIGN TO IMPROVE DRAWING OF HOLLOW-CORE FIBERS

(71) Applicant: CORNING INCORPORATED, CORNING, NY (US)

(72) Inventors: Sushmit Sunil Kumar Goyal, Painted Post, NY (US); Nikolaos Pantelis Kladias, Horseheads, NY (US); Purushotam Kumar, Parsippany, NJ (US)

(21) Appl. No.: 19/273,787

(22) Filed: Jul. 18, 2025

Related U.S. Application Data
(60) Provisional application No. 63/677,504, filed on Jul. 31, 2024.

(51) Int. Cl. C03B 37/03; C03B 37/023

(52) U.S. Cl. CPC C03B 37/032; C03B 37/023; C03B 2205/68

(57) ABSTRACT

A furnace assembly for manufacturing a hollow-core optical fiber from a hollow-core fiber preform includes a furnace having a body defining a body cavity extending along a longitudinal axis between a preform input port and a hollow-core fiber output port. The body cavity is configured to locate the hollow-core optical fiber preform and a process gas. At least one primary heating element is proximate a necking region of the hollow-core optical fiber preform and configured to maintain the necking region at a draw temperature, the draw temperature sufficient to soften the necking region. The process gas occupies a flow field surrounding a cladding outer surface. The flow field extends from the necking region to the preform input port and the process gas has a flow with an average Grashof number less than 1.6×10⁴ in the flow field.

This application claims the benefit of priority to U.S. Provisional Patent Application Ser. No. 63/677,504 filed on Jul. 31, 2024, the content of which is relied upon and incorporated herein by reference in its entirety.

### TECHNICAL FIELD

The present disclosure pertains to the manufacture of an optical fiber within a furnace assembly, and more particularly the furnace design, methods of forming hollow-core optical fibers, and the hollow-core optical fibers produced therefrom.

### BACKGROUND

Optical fibers are utilized to transmit data. More particularly, a transmitter converts information into pulses of electromagnetic radiation and transmits the pulses into the optical fiber. The electromagnetic radiation transmits along the optical fiber to a receiver. The receiver re-converts the pulses of electromagnetic radiation back into information.

Optical fiber often includes a solid core through which the electromagnetic radiation moves and a cladding surrounding the solid core to maintain the electromagnetic radiation within the solid core. The cladding and the solid core exhibit different indices of refraction, and the difference causes the electromagnetic radiation to stay generally within the solid core during transmission due to total internal reflection. The solid core of the optical fiber is often formed of silica-based glass.

Transmission performance of optical fibers with a solid core can suffer from scattering, absorption, and bending losses. The material of the solid core can scatter and absorb the electromagnetic radiation pulses that the optical fiber is transmitting. Further, despite the total internal reflection, some of the intensity of the electromagnetic radiation escapes from the core into the cladding due to external perturbations, such as bending and stresses, or confinement loss. The escape from the core is sometimes referred to as attenuation. The scattering, absorption, and lack of confinement reduce the intensity of the electromagnetic radiation signal pulses guided by the optical fiber, which reduces the ability of the receiver to convert the pulses back into information due to a decreased signal-to-noise ratio as the fiber length increases.

To address attenuation losses, hollow-core optical fibers are under development. Hollow-core optical fibers, as the name suggests, do not include a core of solid material. Rather, the core is a gas, such as air. Due to the absence of a solid core, it is thought that the electromagnetic radiation could transmit without as much scattering and absorption loss. Hollow-core optical fibers also exhibit low latency for optical signals, which provides flexibility in the design of optical networks and data centers.

Optical fibers are typically formed by a process that includes placing a preform of glass into a furnace, heating the preform to melt or soften the glass to a desirable viscosity range, and drawing the preform. The heating and cooling conditions significantly change the behavior of optical fibers (e.g., shape, stress, optical properties, etc.). The role of a furnace, and control over heating conditions becomes even more critical for hollow-core optical fibers as there are thin capillaries inside the hollow-core fiber that define the structure of the cladding. The performance of hollow-core optical fibers is highly sensitive to capillary structure. Even a small fluctuation in the temperature can alter the capillary properties and degrade the optical properties of hollow-core fiber. Non-uniformities in the temperature distribution in the furnace lead to instabilities in the shape and dimensions of capillaries. Precise control of the temperature distribution is needed to maintain the capillary structure needed to optimize the performance of hollow-core optical fibers. The temperature distribution in the furnace (e.g., either in a transient or a steady state) depends on a combination of factors that include draw ratio, process gas inlet positions, process gas flow rates, process gas temperature, maximum temperature of the furnace, etc. Controlling the process gas flow, capillary size variations, and glass temperature fluctuations in a furnace can be difficult for a variety of reasons. There is a need for improved furnace designs that provide more uniform temperature distributions for drawing hollow-core optical fibers from preforms.

### SUMMARY

The present disclosure generally relates to a furnace assembly, a furnace design, production methods, and a resulting hollow-core optical fiber that address those problems and provides stability of airflow profiles within the furnace, uniformity glass temperature profile and stable capillary dimensions, and increased diameter control via active cooling components within the system.

According to a first aspect of the present disclosure, a furnace assembly for manufacturing a hollow-core optical fiber from a hollow-core fiber preform includes a furnace having a body defining a body cavity extending along a longitudinal axis between a preform input port and a hollow-core fiber output port. The body cavity is configured to locate the hollow-core optical fiber preform and a process gas. The hollow-core optical fiber preform includes a cladding tube having a cladding outer surface and a cladding inner surface, the cladding inner surface surrounding the longitudinal axis and defining a preform cavity. A plurality of capillary elements are attached to the cladding inner surface, each of the capillary elements having a capillary inner surface defining a capillary cavity. At least one primary heating element is proximate a necking region of the hollow-core optical fiber preform and is configured to maintain the necking region at a draw temperature, the draw temperature sufficient to soften the necking region. The process gas occupies a flow field surrounding the cladding outer surface, the flow field extending from the necking region to the preform input port, the process gas having a flow with an average Grashof number less than 1.6×10⁴ in the flow field.

According to a second aspect of the present disclosure, the furnace assembly of the first aspect is presented, wherein the flow of the process gas in the flow field is laminar.

According to a third aspect of the present disclosure, the furnace assembly of the first aspect is presented and further includes an upper muffle coupled to the preform input port and defining an upper muffle cavity extending along the longitudinal axis.

According to a fourth aspect of the present disclosure, the furnace assembly of the third aspect is presented and further includes a secondary heating element located proximate the upper muffle and extending along the longitudinal axis at least 15 cm and configured to sufficiently heat the hollow-core optical fiber preform to a uniform temperature prior to the hollow-core optical fiber preform entering the preform input port.

According to a fifth aspect of the present disclosure, the furnace assembly of the fourth aspect is presented, wherein the secondary heating element extends along the longitudinal axis at least 50 cm.

According to a sixth aspect of the present disclosure, the furnace assembly of the fourth aspect is presented, wherein the uniform temperature is less than the draw temperature and over about 50% of the draw temperature.

According to a seventh aspect of the present disclosure, the furnace assembly of the first aspect is presented, wherein the body of the furnace defines a plurality of gas delivery channels for introducing the process gas into the body cavity, including at least a lower gas delivery channel located proximate the hollow-core fiber output port and a middle gas delivery channel located proximate the at least one primary heating element.

According to an eighth aspect of the present disclosure, the furnace assembly of the first aspect is presented, wherein a process gas source is configured to introduce the process gas into the lower gas delivery channel at a first delivery volumetric flow rate and introduce the process gas into the middle gas delivery channel at a second delivery volumetric flow rate, wherein the first delivery volumetric flow rate is less than the second delivery volumetric flow rate.

According to a nineth aspect of the present disclosure, the furnace assembly of the eighth aspect is presented, wherein the first delivery volumetric flow rate is less than the second delivery volumetric flow rate by a factor of 8 or more.

According to a tenth aspect of the present disclosure, the furnace assembly of the eighth aspect is presented, wherein the middle gas delivery channel is configured to direct the process gas toward the necking region.

According to an eleventh aspect of the present disclosure, the furnace assembly of the first aspect is presented, wherein the body of the furnace defines a plurality of cooling channels configured to circulate a cooling liquid proximate the body cavity, the plurality of cooling channels including an upper cooling channel proximate the preform input port and a lower cooling channel proximate the hollow-core fiber output port.

According to a twelfth aspect of the present disclosure, the furnace assembly of the eleventh aspect is presented, wherein the upper cooling channel is coupled to an upper cooling circulation module configured to circulate the cooling liquid at a first rate and the lower cooling channel is coupled to a lower cooling circulation module configured to circulate the cooling liquid at a second rate that is greater than the first rate.

According to a thirteenth aspect of the present disclosure, the furnace assembly of the first aspect is presented, wherein a cooling element is located outside of the body cavity and proximate the hollow-core fiber output port.

According to a fourteenth aspect of the present disclosure, the furnace assembly of the thirteenth aspect is presented, wherein the cooling element is selected from a group comprising: at least one air wipe, at least one air knife, and at least one flow tube.

According to a fifteenth aspect of the present disclosure, the furnace assembly of the first aspect is presented and further includes at least one gas delivery channel, the at least one gas delivery channel is configured to supply the process gas to the body cavity. A process gas source is configured to deliver the process gas into the at least one gas delivery channel at a delivery a volumetric flow rate, wherein a ratio of the delivery a volumetric flow rate to a purging volumetric flow rate from the hollow-core fiber output port is less than 0.3.

According to a sixteenth aspect of the present disclosure, the furnace assembly of the first aspect is presented, wherein the average Grashof number of the process gas in the flow field is less than 1.2×10⁴.

According to a seventeenth aspect of the present disclosure, a method of utilizing a furnace assembly in manufacturing a hollow-core optical fiber from a hollow-core optical fiber preform is provided. The furnace assembly includes a furnace having a body defining a body cavity extending along a longitudinal axis between a preform input port and a hollow-core fiber output port, the furnace further including a primary heating element, and a middle gas delivery channel proximate the primary heating element. The method includes defining a sleeve gap of the middle gas delivery channel, introducing process gas via at least the middle gas delivery channel to a heat zone through the sleeve gap at a volumetric flow rate Q_{hzfr}, and regulating the delivery volumetric flow rate Q_{hzfr} and a purging volumetric flow rate Q_{bpfr} of a purging gas from the hollow-core fiber output port. A ratio of the delivery volumetric flow rate Q_{hzfr} to the purging volumetric flow rate Q_{bpfr} is less than 0.4.

According to an eighteenth aspect of the present disclosure, the method of the seventeenth aspect is presented and further includes regulating the ratio of the delivery volumetric flow rate Q_{hzfr} to the purging volumetric flow rate Q_{bpfr} to less than 0.3.

According to an nineteenth aspect of the present disclosure, the method of the eighteenth aspect is presented, wherein delivery volumetric flow rate Q_{hzfr} and the purging volumetric flow rate Q_{bpfr} satisfy the condition:

$$\frac{{Q}_{bpfr}}{{r}_{funace}} * \frac{2 * sleeve gap}{{Q}_{hzfr}} < 0.3$$

where r_{furnace} is the radius of the body cavity.

According to a twentieth aspect of the present disclosure, the method of the seventeenth aspect is presented and further includes maintaining the Reynold number of the process gas in the heat zone between about 1000 and about 2000, defined by:

$$1000 < R e = \frac{{\dot{m}}_{hzfr}}{2 * {r}_{furnace} * sleeve gap * μ} < 2000$$

where \dot{m}_{hzfr} is a mass flow rate of the process gas from the middle gas delivery channel and u is the dynamic viscosity of the process gas in the heat zone.

According to a twenty first aspect of the present disclosure, the method of the seventeenth aspect is presented and further includes circulating a cooling liquid in an upper cooling channel proximate the preform input port at a first rate and circulating a cooling liquid in a lower cooling channel proximate the hollow-core fiber output port at a second rate that is greater than the first rate.

According to a twenty second aspect of the present disclosure, the method of the seventeenth aspect is presented, wherein the furnace assembly further includes an upper muffle coupled to the preform input port of the furnace and defining an upper muffle cavity extending along the longitudinal axis, and a secondary heating element located proximate the upper muffle and extending along the longitudinal axis. The method further includes heating, with the secondary heating element, the hollow-core optical fiber preform to a uniform temperature in the upper muffle cavity.

According to a twenty third aspect of the present disclosure, the method of the twenty second aspect is presented and further includes heating a necking region of the hollow-core optical fiber preform in the heat zone, with the primary heating element, at a draw temperature, the draw temperature sufficient to soften the necking region, and wherein the uniform temperature is less than the draw temperature and over about 50% of the draw temperature.

According to a twenty fourth aspect of the present disclosure, the method of the seventeenth aspect is presented and further includes introducing a process gas through at least the middle gas delivery channel, the process gas being introduced at a flow with an average Grashof number less than 1.6×10⁴ in the flow field.

Additional features and advantages will be set forth in the detailed description which follows, and in part will be readily apparent to those skilled in the art from that description or recognized by practicing the various aspects described herein, including the detailed description which follows, the claims, as well as the appended drawings.

It is to be understood that both the foregoing general description and the following detailed description are merely exemplary and are intended to provide an overview or framework to understanding the nature and character of the claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 is a perspective view of a hollow-core optical fiber of the present disclosure, illustrating a first end, a second end, and a fiber longitudinal axis extending between the first end and the second end;

FIG. 2 is an elevational view of a cross-section of an embodiment of the hollow-core optical fiber taken through line II-II of FIG. 1, illustrating a support ring separating inner capillaries within an inner space from outer capillaries within an outer space;

FIG. 3 is an elevational view of a cross-section of an embodiment of the hollow-core optical fiber taken through line III-III of FIG. 1, illustrating the same features as FIG. 2 but further including nested capillaries within the inner capillaries;

FIG. 4 is an elevational view of a cross-section of an embodiment of the hollow-core optical fiber taken through line IV-IV of FIG. 1, illustrating the support ring separating the inner capillaries within the inner space from solid rods within the outer space;

FIG. 5 is an elevational view of a cross-section of an embodiment of the hollow-core optical fiber taken through line V-V of FIG. 1, illustrating the same features as FIG. 4 but further including the nested capillaries within the inner capillaries;

FIG. 6 is an elevational view of a cross-section of an embodiment of the hollow-core optical fiber taken through line VI-VI of FIG. 1, illustrating the support ring separating the inner capillaries within the inner space from two sets of the outer capillaries within the outer space, each of the two sets having a different outer radius;

FIG. 7 is an elevational view of a cross-section of an embodiment of the hollow-core optical fiber taken through line VII-VII of FIG. 1, illustrating the same features as FIG. 6 but further including the nested capillaries within the inner capillaries;

FIG. 8 is an elevational schematic view of a hollow-core optical fiber preform utilized for drawing a hollow-core optical fiber;

FIG. 9A is a cross-sectional, partially schematic view of a furnace assembly that can be implemented to produce the hollow-core optical fiber depicted in FIGS. 1-7;

FIG. 9B is an enlarged, cross-sectional view of a preform input port of a furnace assembly;

FIG. 9C is an enlarged, cross-sectional view of a hollow-core fiber output port of a furnace assembly;

FIG. 10A is a heat map of a furnace assembly depicting temperature distribution and benefits associated with maintaining the ratio of the process gas;

FIG. 10B is a velocity magnitude map of process gas within of a furnace assembly depicting benefits associated with maintaining the ratio of the process gas to reduce recirculation of the process gas;

FIG. 11A is a heat map of a furnace assembly depicting temperature distribution and benefits associated with maintaining a flow of a cooling liquid;

FIG. 11B is a velocity magnitude map of process gas within of a furnace assembly depicting benefits associated with maintaining a flow of a cooling liquid; and

FIG. 12 is a flow chart depicting a method of utilizing a furnace assembly in manufacturing a hollow-core optical fiber from a hollow-core optical fiber preform.

### DETAILED DESCRIPTION

Additional features and advantages will be set forth in the detailed description which follows and will be apparent to those skilled in the art from the description, or recognized by practicing the various aspects as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made only with reference to the figures as drawn and, unless otherwise indicated, are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

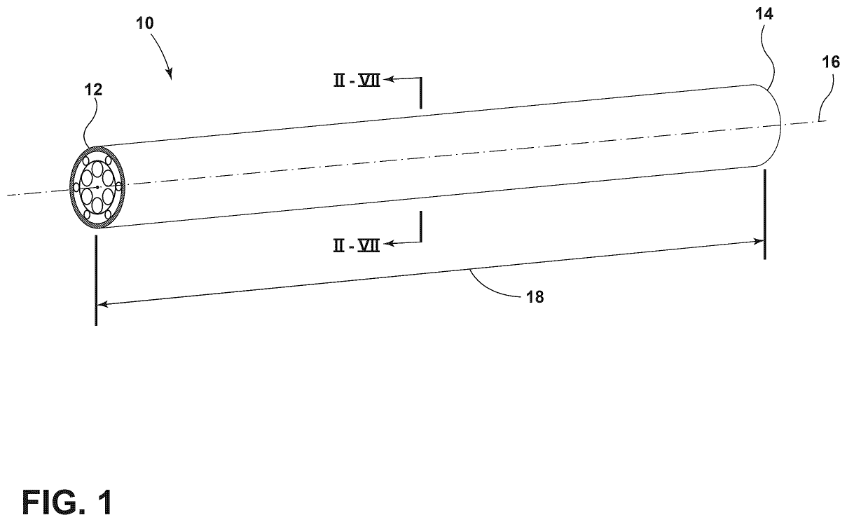

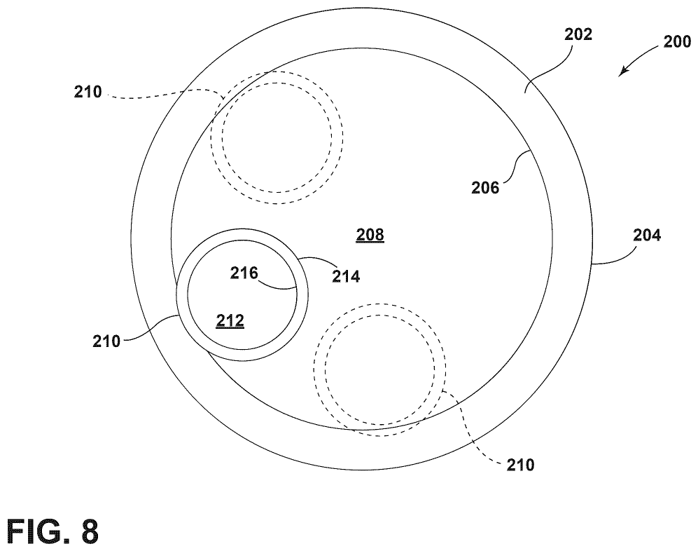

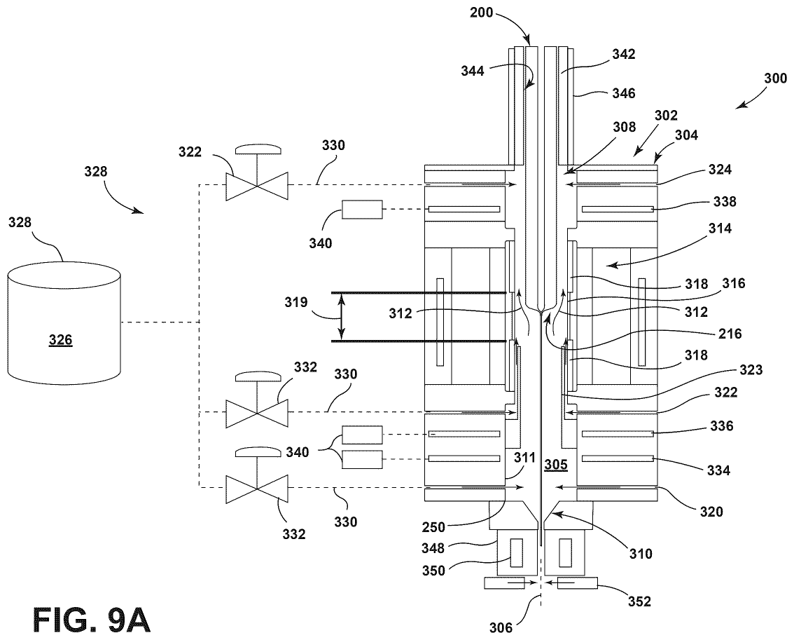

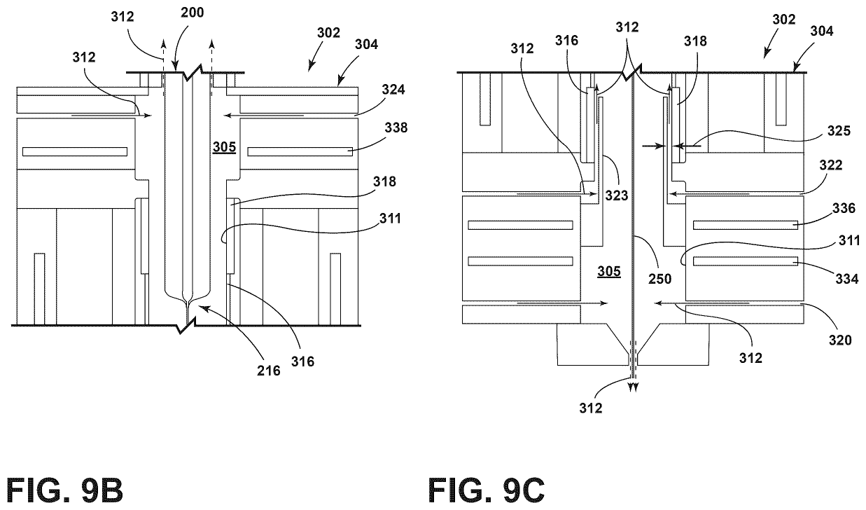

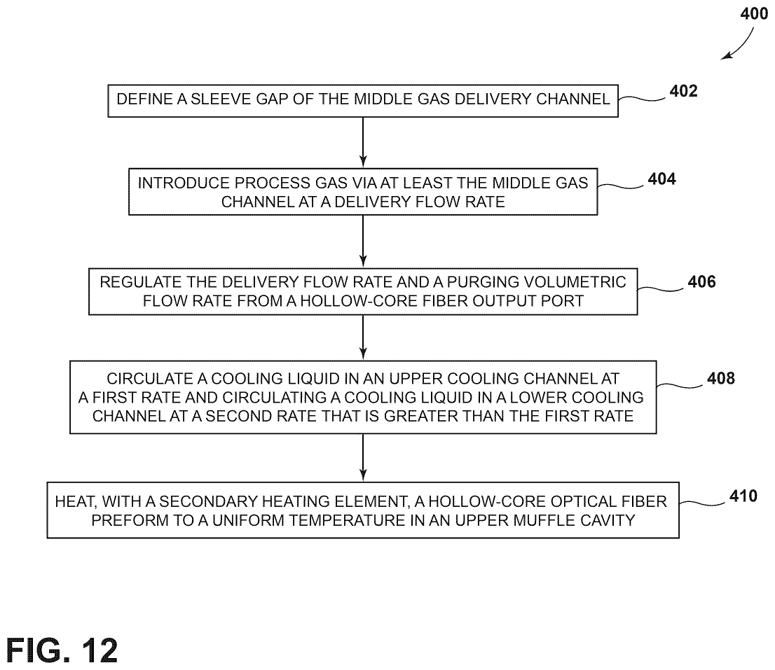

Referring initially to FIGS. 1-7, various implementations of a hollow-core optical fiber are provided. The various implementations of the hollow-core optical fiber may be assembled or produced, for example, by processing a hollow-core optical fiber preform 200 depicted in FIG. 8, with a furnace assembly 300 depicted in FIGS. 9A-9C and/or the method depicted in FIG. 12 and the detailed description in reference thereto. It is noted that the various implementations depicted in FIGS. 1-7 are representative designs for hollow-core optical fibers and that the advantages of the furnace and methods described herein extend to all designs of hollow-core optical fibers that benefit from dimensional stability of capillaries or other cladding elements operable to confine light in the hollow core of a hollow-core optical fiber through one or more of the anti-resonant effect, negative curvature, and photonic bandgap effect.

Referring now specifically to FIG. 1, a hollow-core optical fiber 10 is herein disclosed. The hollow-core optical fiber 10 includes a first end 12, a second end 14, and a fiber longitudinal axis 16. The fiber longitudinal axis 16 extends from the first end 12 to the second end 14 through the center of hollow-core optical fiber 10. In addition, the hollow-core optical fiber 10 has a length 18 that likewise extends from the first end 12 to the second end 14. The length 18 of the hollow-core optical fiber 10 is not particularly important and can range from less than a meter to many kilometers. Several groupings of embodiments of the hollow-core optical fiber 10 are now described.

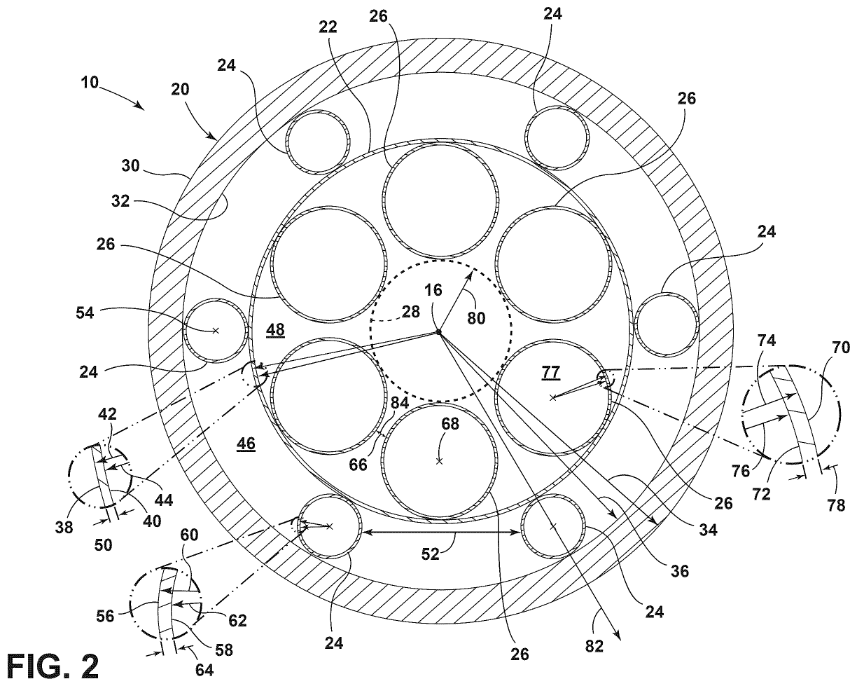

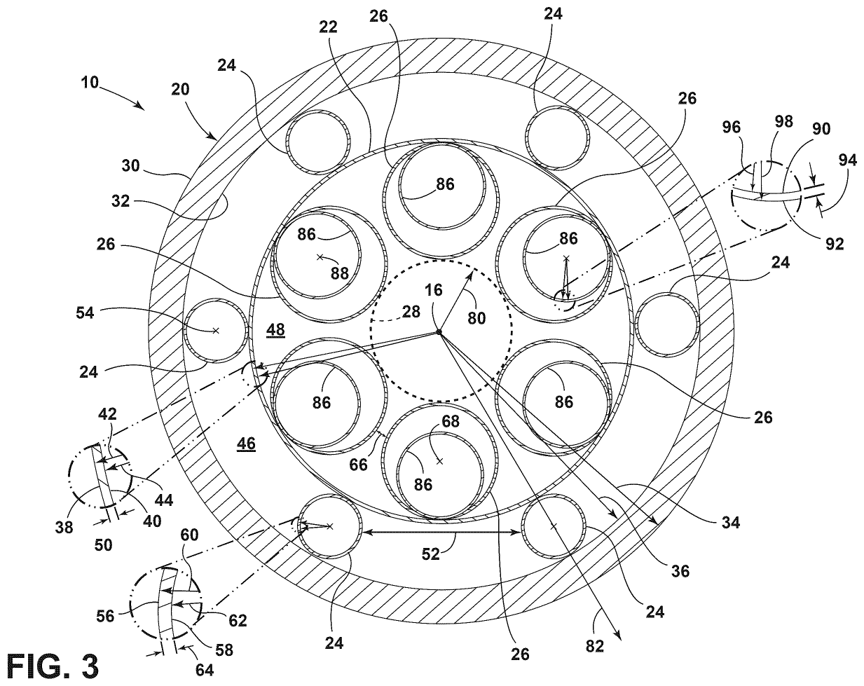

Referring now to FIGS. 2 and 3, embodiments of the hollow-core optical fiber 10 include a cladding tube 20, a support ring 22, outer capillaries 24, inner capillaries 26, and an effective core region 28. The cladding tube 20 extends longitudinally from the first end 12 to the second end 14 of the hollow-core optical fiber 10. The fiber longitudinal axis 16 extends through the cladding tube 20. The cladding tube 20 is disposed radially around the fiber longitudinal axis 16, as is particularly illustrated in the figures. The cladding tube 20 includes an outer surface 30 and an inner surface 32. The outer surface 30 is at an outer radius 34 from the fiber longitudinal axis 16, while the inner surface 32 is at an inner radius 36 from the fiber longitudinal axis 16. In embodiments, the inner radius 36 is within a range of from 40 μm to 75 μm. For example, the inner radius 36 can be 40 μm, 45 μm, 50 μm, 55 μm, 60 μm, 65 μm, 70 μm, 75 μm, or within any range bound by any two of those values (e.g., from 45 μm to 65 μm, from 50 μm to 60 μm, and so on). The outer radius 34 can be 50 μm, 55 μm, 60 μm, 62.5 μm, 65 μm, 70 μm, 75 μm, 100 μm, 125 μm, 150 μm, 250 μm, 300 μm, or within any range bound by any two of those values (e.g., from 50 μm to 150 μm, from 62.5 μm to 125 μm, and so on).

The support ring 22 is disposed within the cladding tube 20. The support ring 22 likewise extends longitudinally from the first end 12 to the second end 14 of the hollow-core optical fiber 10. The fiber longitudinal axis 16 extends through the support ring 22. The support ring 22 is disposed radially around the fiber longitudinal axis 16. The support ring 22 includes an outer surface 38 and an inner surface 40. The outer surface 38 is at an outer radius 42 from the fiber longitudinal axis 16, while the inner surface 40 is at an inner radius 44 from the fiber longitudinal axis 16. The outer surface 38 of the support ring 22 is separated from the inner surface 32 of the cladding tube 20 by an outer space 46. The inner surface 40 of the support ring 22 forms an inner space 48. The support ring 22 has a thickness 50 between the outer surface 38 and the inner surface 40. The support ring 22 is illustrated in the FIGS. 2 and 3 as perfectly round. However, pressure and stress effects during manufacture of the hollow-core optical fiber 10 can deform the support ring 22 and cause the shape of the support ring 22 to deviate from the perfectly round shape to, for example, an oval or a round polygon shape. However, the functionality of the support ring 22 in shapes deviating from the perfectly round shape remain similar to the functionality of the support ring 22 having a perfectly round shape.

The outer capillaries 24 are substantially evenly spaced around the fiber longitudinal axis 16 within the outer space 46. An outer gap 52 separates each pair of the outer capillaries 24 that are adjacent to each other. The outer gaps 52 are substantially the same, such as manufactured with the intention to be the same but recognizing that manufacturing imprecision results in variations among the outer gaps 52.

Each of the outer capillaries 24 extend from the first end 12 to the second end 14 of the hollow-core optical fiber 10 along an outer longitudinal axis 54. The outer longitudinal axes 54 are parallel to the fiber longitudinal axis 16. Each of the outer capillaries 24 is fused to both the inner surface 32 of the cladding tube 20 and the outer surface 38 of the support ring 22. Each of the outer capillaries 24 includes an outer surface 56 and an inner surface 58. The outer surface 56 is at an outer radius 60 from the outer longitudinal axis 54. The inner surface 58 is at an inner radius 62 from the outer longitudinal axis 54. Each of the outer capillaries 24 further includes a thickness 64 between the outer surface 56 and the inner surface 58 thereof.

The inner capillaries 26 are substantially evenly spaced around the fiber longitudinal axis 16 within the inner space 48. An inner gap 66 separates each pair of the inner capillaries 26 that are adjacent to each other. The inner gaps 66 are substantially the same, such as manufactured with the intention to be the same but recognizing that manufacturing imprecision results in variations among the inner gaps 66.

Each of the inner capillaries 26 extends from the first end 12 to the second end 14 of the hollow-core optical fiber 10 along an inner longitudinal axis 68. The inner longitudinal axes 68 are parallel to the fiber longitudinal axis 16. Each of the inner capillaries 26 is fused to the inner surface 40 of the support ring 22. Each of the inner capillaries 26 includes an outer surface 70 and an inner surface 72. The outer surface 70 is at an outer radius 74 from the inner longitudinal axis 68. The inner surface 72 is at an inner radius 76 from the inner longitudinal axis 68 and defines a capillary space 77. Each of the inner capillaries 26 further includes a thickness 78 between the outer surface 70 and the inner surface 72 thereof.

The inner capillaries 26 define the effective core region 28 of the hollow-core optical fiber 10. The fiber longitudinal axis 16 extends through the effective core region 28. The effective core region 28 extends from the first end 12 to the second end 14 of the hollow-core optical fiber 10. The effective core region 28 includes a core radius 80 from the fiber longitudinal axis 16. The core radius 80 is tangential to the outer surfaces 70 of the inner capillaries 26.

In embodiments, such as those illustrated, the outer capillaries 24 are positioned opposite the inner gaps 66 between the inner capillaries 26. Stated another way, radial lines 82 can be conceptualized to extend outward from the fiber longitudinal axis 16. Each of the radial lines 82 extends through a different one of the inner gaps 66, and may extend through a midpoint 84 of each respective inner gaps 66. The outer capillaries 24 are positioned so that each of the radial lines 82 additionally extends through a different one of the outer capillaries 24, and may extend through the outer longitudinal axis 54 thereof.

The outer radii 60 of the outer capillaries 24 can be intended to be the same. Likewise, the outer radii 74 of the inner capillaries 26 can be intended to be the same. However, due to manufacturing limitations, the outer radii 60 of the outer capillaries 24 may vary and may not be exactly the same, and likewise the outer radii 74 of the inner capillaries 26 may vary and may not be exactly the same.

In any event, with these embodiments of FIGS. 2 and 3, the outer radii 60 of the outer capillaries 24 share a common first value (or fall within a first range) and the outer radii 74 of the inner capillaries 26 share a common second value (or fall within a second range). The common first value (or the first range) is less than the common second value (or the second range). Such an arrangement provides flexibility to optimize the dimensions of the inner space 48 and the outer space 46 to maximize the anti-resonant effects to confine the light better within in the effective core region 28.

In embodiments, the hollow-core optical fiber 10 includes from 3 to 12 outer capillaries 24 and from 3 to 8 inner capillaries 26. For example, the hollow-core optical fiber 10 can include 3, 4, 5, 6, 7, 8, 9, 10, 11, or 12 outer capillaries 24, or any number of outer capillaries 24 within any range bound by any two of those values (e.g., from 4 to 10, from 9 to 11, and so on). Likewise, the hollow-core optical fiber 10 can include 3, 4, 5, 6, 7, or 8 inner capillaries 26, or any number of inner capillaries 26 within any range bound by any two of those values (e.g., from 4 to 7, from 3 to 6, and so on).

In embodiments, such as that illustrated at FIG. 3, the hollow-core optical fiber 10 further includes nested capillaries 86. The nested capillaries 86 are disposed within the capillary spaces 77 of the inner capillaries 26. In particular, each of the nested capillaries 86 is disposed in a different one of the inner capillaries 26 and fused to the inner surface 72 of the respective inner capillary 26. Each of the nested capillaries 86 extends from the first end 12 to the second end 14 of the hollow-core optical fiber 10. Each of the nested capillaries 86 includes a nested longitudinal axis 88. The nested longitudinal axis 88 extends parallel to the fiber longitudinal axis 16 from the first end 12 to the second end 14. Each of the nested capillaries 86 further includes an inner surface 90, an outer surface 92, and a thickness 94. The inner surface 90 is at an inner radius 96 from the nested longitudinal axis 88. The outer surface 92 is at an outer radius 98 from the nested longitudinal axis 88. The thickness 94 is between the outer surface 98 and the inner surface 90. The inclusion of the nested capillaries 86 can further reduce confinement loss. In more particular embodiments, the hollow-core optical fiber 10 may include exactly 5 outer capillaries 24, exactly 5 inner capillaries 26, and exactly 5 nested capillaries 86.

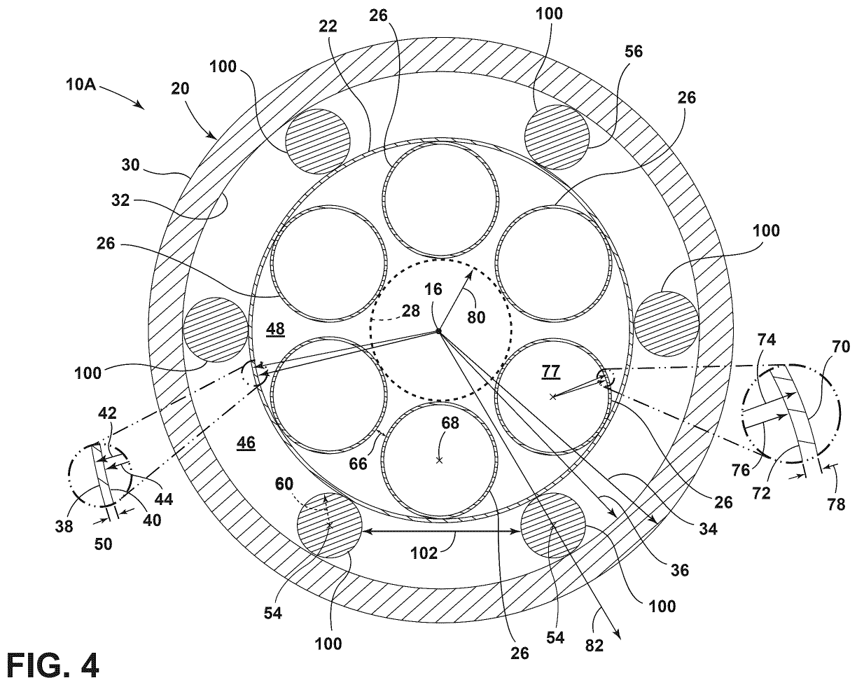

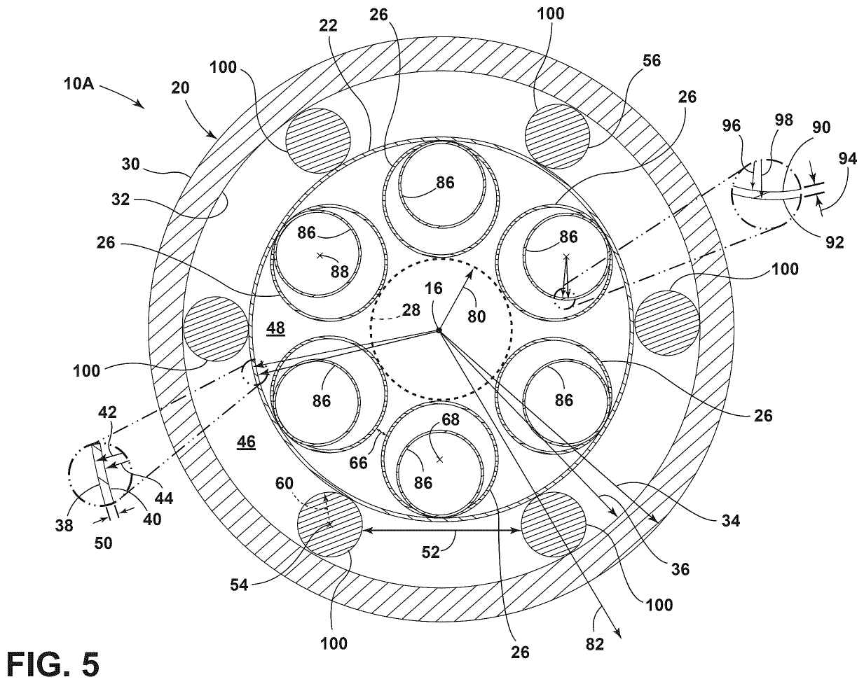

Referring now to FIGS. 4 and 5, other embodiments of the hollow-core optical fiber 10 (hereinafter labeled 10A) are now disclosed. These embodiments share in common many of the same features as the embodiments of the hollow-core optical fiber 10 discussed in connection with FIGS. 2 and 3. For example, the hollow-core optical fiber 10A includes the fiber longitudinal axis 16, the cladding tube 20, the support ring 22, the inner capillaries 26, the effective core region 28, and optionally the nested capillaries 86 within the inner capillaries 26, just as the hollow-core optical fiber 10 of FIGS. 2 and 3. The discussion of those components above apply equally as well to these embodiments of the hollow-core optical fiber 10A.

However, instead of the outer capillaries 24, these embodiments of the hollow-core optical fiber 10A include solid rods 100. The solid rods 100 are substantially evenly spaced around the fiber longitudinal axis 16 within the outer space 46. A rod gap 102 separates each pair of the solid rods 100 that are adjacent to each other. The rod gaps 102 are substantially the same, such as manufactured with the intention to be the same but recognizing that manufacturing imprecision results in variations among the rod gaps 102. The inclusion of the solid rods 100 does not affect confinement loss significantly (compared to inclusion of the outer capillaries 24 instead) but simplifies manufacturing, because the solid rods 100 are stronger and easier to handle than the outer capillaries 24 and provide more rigid support structure to the hollow-core optical fiber 10A and preform from which the hollow-core optical fiber 10A is drawn. In embodiments, like the outer capillaries 24 discussed above, the solid rods 100 are positioned opposite the inner gaps 66 between the inner capillaries 26.

Each of the solid rods 100 is fused to both the inner surface 32 of the cladding tube 20 and the outer surface 38 of the support ring 22. Each of the solid rods 100 includes an outer longitudinal axis 54 and an outer surface 56. Each of the solid rods 100 extends from the first end 12 to the second end 14 of the hollow-core optical fiber 10, with the outer longitudinal axis 54 extending parallel to the fiber longitudinal axis 16. The outer surface 56 is at an outer radius 60 from the outer longitudinal axis 54.

The discussion above in connection with the embodiments of FIGS. 2 and 3 regarding values for the thicknesses 50, 78, 94 of the support ring 22, the inner capillaries 26, and, if included, the nested capillaries 86 pertains equally as well to the embodiments of FIGS. 4 and 5. Similarly, the discussion above in connection with the embodiments of FIGS. 2 and 3 regarding values for the outer radius 42 of the support ring 22 and the outer radii 98 of the nested capillaries 86 pertains equally as well to the embodiments of FIGS. 4 and 5. In embodiments, the thicknesses 78 of the inner capillaries 26 are predetermined to minimize confinement loss for electromagnetic radiation of a predetermined wavelength 18 or wavelength 18 range.

In embodiments, the outer radii 60 of the solid rods 100 share a common first value or fall within a first range. The outer radii 74 of the inner capillaries 26 share a common second value or fall within a second range. The common first value, or the first range, can be different and not overlapping with the common second value, or the second range. In other instances, the common first value (or the first range) and the common second value (or the second range) are the same or overlap.

In embodiments, the hollow-core optical fiber 10A includes from 3 to 12 solid rods 100. For example, the number of the solid rods 100 of the hollow-core optical fiber 10A can be 3, 4, 5, 6, 7, 8, 9, 10, 11, 12, or within any range bound by any two of those values (e.g., from 4 to 10, from 5 to 11). In embodiments, the hollow-core optical fiber 10A includes from 3 to 8 inner capillaries 26. For example, the number of the inner capillaries 26 can be 3, 4, 5, 6, 7, 8, or within any range bound by any two of those values (e.g., from 4 to 7, from 3 to 5, and so on).

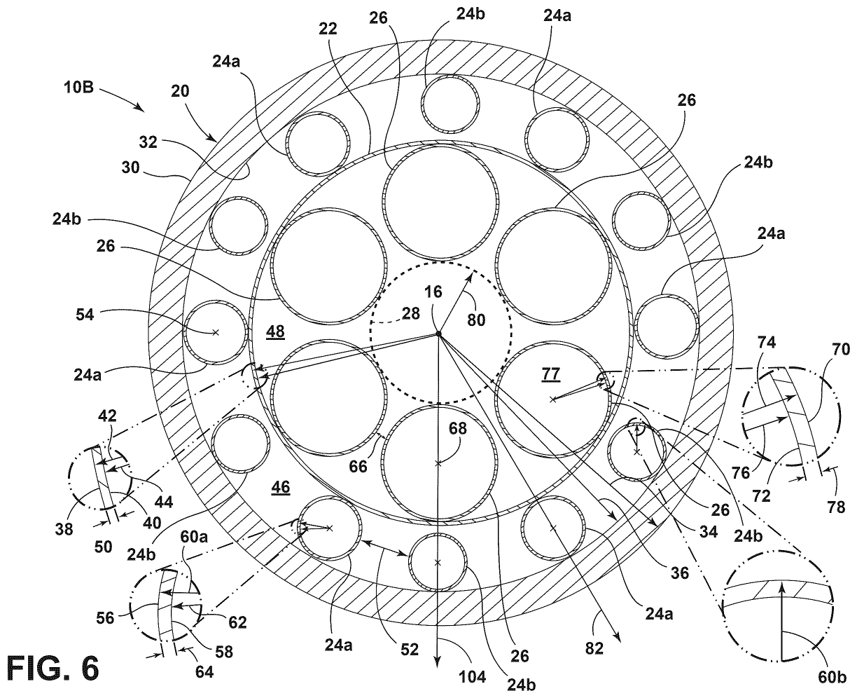

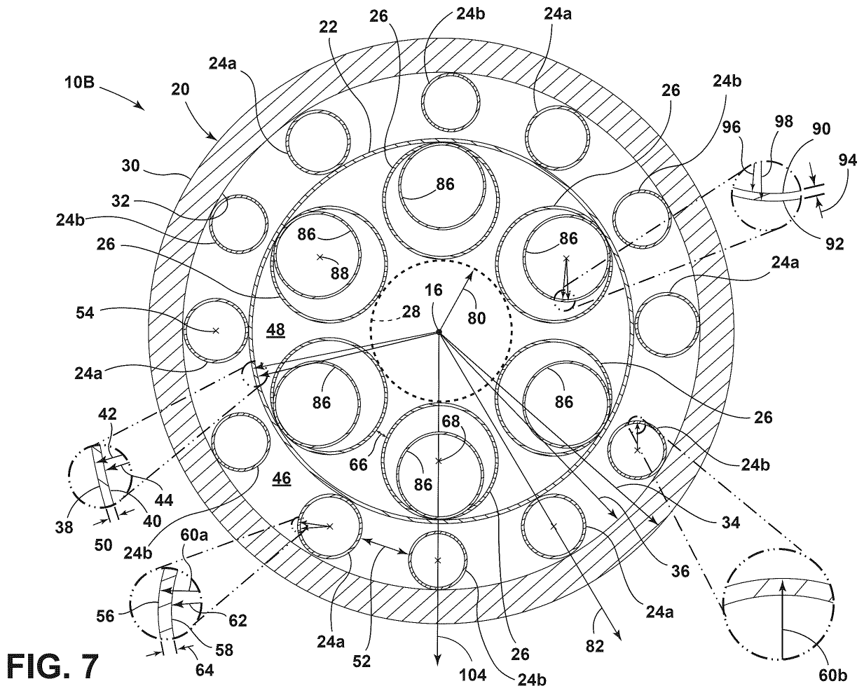

Referring now to FIGS. 6 and 7, other embodiments of the hollow-core optical fiber 10 (hereinafter labeled 10B) are now disclosed. These embodiments share in common many of the same features as the embodiments of the hollow-core optical fiber 10 discussed in connection with FIGS. 2 and 3. For example, the hollow-core optical fiber 10B includes the fiber longitudinal axis 16, the cladding tube 20, the support ring 22, the inner capillaries 26, and the effective core region 28, and optionally the nested capillaries 86 within the inner capillaries 26, just as the hollow-core optical fiber 10 of FIGS. 2 and 3. The discussion of those components above apply equally as well to these embodiments of the hollow-core optical fiber 10B. However, in these embodiments of the hollow-core optical fiber 10B, the outer radii 60 of some of the outer capillaries 24 (hereinafter outer radii 60a of outer capillaries 24a) share a common first value or fall within a first range, while the outer radii 60 of the other of the outer capillaries 24 (hereinafter outer radii 60b of outer capillaries 24b) share a common second value or fall within a second range. The common first value (or the first range) and the second common value (or the second range) are not the same and do not overlap. In addition, the common second value (or the second range) is smaller than the common first value (or the first range). The outer capillaries 24a that share the common first value (or falling within the first range) are fused to both the inner surface 32 of the cladding tube 20 and the outer surface 38 of the support ring 22. The outer capillaries 24b sharing the common second value (or falling within second range) are fused to the inner surface 32 of the cladding tube 20 and may not be fused to the support ring 22.

In embodiments, like the solid rods 100 above, the outer capillaries 24a with the outer radii 60a sharing the common first value (or falling within the first range) are positioned opposite the inner gaps 66 between the inner capillaries 26. In contrast, the outer capillaries 24b with the outer radii 60b sharing the common second value (or falling within the second range) are positioned opposite the inner capillaries 26. Stated another way, second radial lines 104 can be conceptualized to extend outward from the fiber longitudinal axis 16. Each of the second radial lines 104 extends through inner longitudinal axis 68 of a different one of the inner capillaries 26. The outer capillaries 24b with the outer radii 60b sharing the common second value (or falling within the second range) are positioned so that each of the second radial lines 104 additionally extends through the outer longitudinal axis 54 of a different one of the outer capillaries 24b with the outer radii 60b sharing the common second value (or falling within the second range). In contrast, radial lines 82 extend through both the inner gaps 66 between the inner capillaries 26 and the outer capillaries 24a with the outer radii 60a sharing the first common value (or falling within the first range), such as through the longitudinal axis 54 thereof.

In more particular embodiments, the hollow-core optical fiber 10B has the following parameters of this paragraph. In these embodiments, the hollow-core optical fiber 10B includes exactly 12 of the outer capillaries 24a, 24b and exactly 6 of the inner capillaries 26. Of the 12 outer capillaries 24a, 24b, the outer radii 60a of 6 of them share the common first value (or are within the first range) and the outer radii 60b of 6 of them share the common second value (or are within the second range).

Although not explicitly depicted, other designs of hollow-core optical fibers and corresponding preforms are known in the art and within the scope of this disclosure. For example, designs lacking support ring 22, outer capillaries 24/24a/24b, and solid rods 100 are known. In some such designs, inner capillaries 26, with or without nested capillaries 86, are fused directly to inner surface 32 of cladding tube 20.

With reference now to FIG. 8, an embodiment of the hollow-core optical fiber preform 200 is schematically depicted. The hollow-core optical fiber preform 200 is a precursor to a hollow-core optical fiber, such as the hollow-core optical fibers 10, 10A, 10B or other designs, and may share the same general structures and may also share the same relative dimensions. However, the absolute dimensions of the components are different based on a draw ratio according to which the hollow-core optical fiber preform 200 is drawn and thinned to form a hollow-core optical fiber. More particularly, including each, but without being strictly bound to any of the particular, hollow-core optical fiber 10, 10A, 10B implementations depicted in FIGS. 1-7, the hollow-core optical fiber preform 200 may including a cladding tube 202 (e.g., associated with cladding tube 20) having a cladding outer surface 204 and a cladding inner surface 206, the cladding inner surface 206 defines a preform cavity 208 (e.g., associated with inner space 48) and a plurality of capillary elements 210 (e.g., associated with outer capillaries 24 and/or inner capillaries 26) attached or otherwise coupled to the cladding inner surface 206. Each of the capillary elements 210 have a capillary inner surface 212 (e.g., associated with inner surface 72) defining a capillary cavity 214 (e.g., associated with capillary space 77). As best depicted in FIG. 9A, when the hollow-core optical fiber preform 200 is subjected to a draw temperature that is sufficient to soften the hollow-core optical fiber preform 200, a necking region 216 develops where a radius of the cladding outer surface 204 and structures therein begin to soften, draw, and shrink. More specifically, necking region 216 corresponds to the region along longitudinal axis 306 extending from the point where the diameter of hollow-core optical fiber preform 200 begins to decrease to the point at which the diameter of optical fiber 250 stabilizes (also referred to as the “forming point” of optical fiber 250).

With reference now to FIGS. 9A-9C, the furnace assembly 300 is depicted. The furnace assembly 300 may be configured as a down drive-style of furnace that is generally annular in shape. The furnace assembly 300 may be implemented for manufacturing the various hollow-core optical fibers 10, 10A, 10B depicted in FIGS. 1-7 from the hollow-core optical fiber preform 200. The furnace assembly 300 includes a furnace 302 with a body 304 defining a body cavity 305 extending along a longitudinal axis 306 between a preform input port 308 and a hollow-core fiber output port 310. The body cavity 305 may be defined by a furnace wall 311, with a radius r_{furnace}, and is configured to locate the hollow-core optical fiber preform 200 and a process gas 312, for example, such that the longitudinal axis 306 extends through the preform cavity 208 and an inner space (e.g., associated with the inner space 48) of the hollow-core optical fiber 250. The furnace 302 includes at least one primary heating element 314 that is proximate the necking region 216 of the hollow-core optical fiber preform 200 and configured to maintain the necking region 216 at the draw temperature. The draw temperature is sufficient to soften the necking region 216 as previously described. The process gas 312 occupies a flow field surrounding the cladding outer surface 204, and the flow field extends from the necking region 216 to the preform input port 308. The process gas 312 may have a flow with an average Grashof number that is less than 1.6×10⁴, or less than 1.4×10⁴, or less than 1.2×10⁴, or less than 1.0×10⁴, or less than 0.8×10⁴ in the flow field.

More particularly, for a given aspect ratio (height to width) of the cavity and inner to outer radii ratio, the non-dimensional parameter that describes the flow of the process gas in the flow field is the Grashof number, Gr, defined by the following equation:

$$G r = \frac{g β ( Δ T ) {L}_{c}^{3}}{{v}^{2}}$$

where, g is the gravitational acceleration, β is the coefficient of thermal expansion of the process gas (β=1/T for ideal gas), L_{c} is the characteristic length (=gap between the outer surface of the preform/fiber in the flow field and the nearest boundary surface in an outwardly radial direction from the outer surface of the preform/fiber in the flow field), ΔT is the temperature difference between the outer surface of the preform/fiber and the boundary surface of the flow field, and v is the gas kinematic viscosity of the process gas in the flow field. The Grashof number can be determined for any cross-section transverse to longitudinal axis 306 in the flow field and averaged over all cross-sections in the flow field to determine an average Grashof number. When the Grashof number is small, the resulting flow of the process gas 312 is purely vertical, and the lateral heat transport is due to conduction. On the other hand, when the Grashof number exceeds a critical value, the parallel flow becomes unstable, and a more complex flow develops in the flow field with eddies, turbulence, and/or recirculation. Unstable flow leads to transient and/or permanent gradients in temperature in the flow field that lead to non-uniformity in capillary dimensions of hollow-core optical fiber 250 as it is drawn from hollow-core optical fiber preform 200. The critical Grashof number for the transition to unstable flow varies with draw conditions and preform composition used for drawing hollow-core optical fibers. Relevant factors include dimensions of the flow field, temperature of the necking region, selection of process gas etc. In embodiments applicable to draw of hollow-core optical fibers from hollow-core optical fiber preforms, the furnace 302 utilizes and controls the process gas 312 at a flow in the flow field with an average Grashof number that is less than 1.6×10⁴, or less than 1.4×10⁴, or less than 1.2×10⁴, or less than 1.0×10⁴, or less than 9.0×10³, or between about 7.0×10³ and 1.6×10⁴, or between about 8.0×10³ and 1.4×10⁴, or between about 9.0×10³ and 1.2×10⁴. In some implementations, the flow of the process gas 312 in the flow field is laminar.

With continued reference to FIGS. 9A-9C, at least one heating element 314 may include a central piece 316 in conductive communication with a pair of adjacent conduction modules 318. In operation, an applied conduction may be transferred between the conduction modules 318 through the central piece 316. The central piece 316 may be formed of a material with high resistivity, such as graphite that generates heat when exposed to the applied conduction. The resistivity of central piece 316 is higher than the resistivity of adjacent conduction modules 318. When energized, the central piece 316 defines a heat zone 319 that heats and maintains the necking region 216 at the draw temperature.

The body 304 of the furnace 302 may define a plurality of gas delivery channels for introducing the process gas 312 into the body cavity 305. The plurality of gas delivery channels may include a lower gas delivery channel 320 located proximate the hollow-core fiber output port 310, a middle gas delivery channel 322 located proximate the at least one primary heating element 314, and an upper gas delivery channel 324 located proximate the preform input port 308. In some embodiments, the middle gas delivery channel 322 may be at least partially defined by an air guide piece 323 extending along the longitudinal axis 306 and guiding process gas 312 over the heating element 314 in a direction (e.g., an upward direction oriented towards the preform input port 308) towards the necking region 216 and heat zone 319. One or more process gas sources 326 may be in fluid communication with the plurality of gas delivery channels. Preferred process gases 312 include inert gases such as Ar, He, Kr, N₂. In some implementations, the process gas source 326 may be fluidically connected to the plurality of gas delivery channels with a manifold 328, with independent gas lines 330 to each of the gas delivery channels. Each gas line 330 may have a flow control valve 332 for independently controlling the flow rates, volumes, and velocities of the process gas 312 introduced through the gas delivery channels and into the body cavity 305. In operation, the process gas 312 is purged through the preform input port 308 and the hollow-core fiber output port 310. In other implementations, each gas delivery channel may be connected to a different process gas source 326.

In some implementations, the process gas source 326 (e.g., in conjunction with the flow control valves 332) is configured to introduce the process gas 312 into the lower gas delivery channel 320 at a first flow (e.g., a first volumetric flow rate, introduce the process gas 312 into the middle gas delivery channel 322 at a second flow, and introduce the process gas 312 into the upper gas delivery channel 324 at a third flow. The second flow rate (e.g., the second volumetric flow rate) may be greater than the first flow and the third flow, and the first flow may be less than the third flow. In some implementations, the second gas flow is greater than the first gas flow by a factor of at least 5, for example, at least 6, at least 7, at least 8, at least 9, at least 10, between 9 and 10, or about 10.

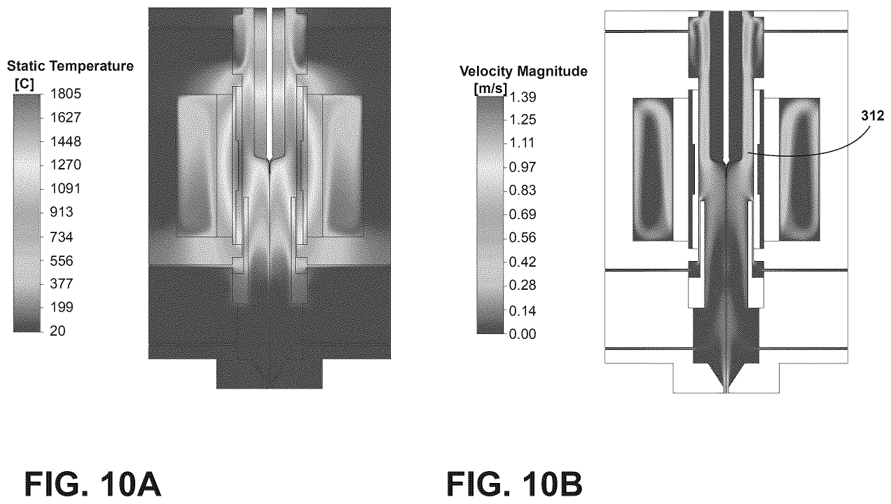

With reference now to FIGS. 9A-10B, recirculation of the flow of the process gas 312 within the body cavity 305 is a potential source of temporal temperature fluctuations and capillary size variation. FIGS. 10A and 10B show, respectively, the distribution of temperature and flow velocity of the process gas in body cavity 305, including in the necking region and the flow field. As depicted in FIGS. 10A and 10B, the recirculation can be prominent around the necking region 216. The main sources of this recirculation are overlapping streams of the process gas 312 and changes in the cross-sectional area of process gas flow in the body cavity 305 above and below the necking region 216. The latter source is difficult to avoid, as it depends on the draw ratio. However, adverse effects due to the overlapping streams of the process gas 312 can be mitigated by managing the flow within the body cavity 305 to reduce or eliminate the recirculation in body cavity 305 proximate the necking region 216 (e.g., including in the heat zone 319). By managing the flow within the body cavity 305, a temperature of the hollow-core optical fiber preform 200 is uniformly heated and remains within a desired operating temperature range to enable stable flow of the process gas 312. More particularly, the furnace assembly 300 maintains the flow of the process gas with an average Grashof number that is less than 1.6×10⁴ in the flow field as previously described. For example, the furnace assembly 300 is configured to maintain a certain ratio of the process gas 312 that is passed through the heat zone 319 and of the process gas 312 that is purged through the hollow-core fiber output port 310. Stated another way, the furnace assembly 300 is configured to maintain a certain ratio of the process gas 312 that is introduced and of the process gas 312 that is purged through the hollow-core fiber output port 310 to reduce or eliminate the recirculation in body cavity 305 proximate the necking region 216 (e.g., including in the heat zone 319). The dimensionless expression for the ratio is given by

$$\frac{{Q}_{bpfr}}{{r}_{funace}} * \frac{2 * sleeve gap}{{Q}_{hzfr}} < 0.3$$

where, Q_{bpfr} is a volumetric flow rate of process gas 312 supplied through lower gas delivery channel 320, r_{furnace} is the furnace radius (e.g., the radius of furnace wall 311 defining the body cavity 305), sleeve gap 325 is the width of the middle gas delivery channel 322 (e.g., the portion of the middle gas delivery channel 322 defined by the air guide piece 323) directing process gas 312 to heat zone 319, and Q_{hzfr} is a total volumetric flow rate of process gas 312 introduced via the gas delivery channels to heat zone 319.

Further, the Reynold number of process gas 312 in the heat zone 319 is preferably maintained above 1000 and less than 2000 based on the following expression.

$$1000 < R e = \frac{{\dot{m}}_{hzfr}}{2 * {r}_{furnace} * sleeve gap * μ} < 2000$$

Where, Re is the Reynolds number, μ is the dynamic viscosity of the fluid (e.g., Pa*s or N*s/m² or kg/(m*s)), and \dot{m}_{hzfr} is the mass flow rate of process gas 312 in the heat zone 319.

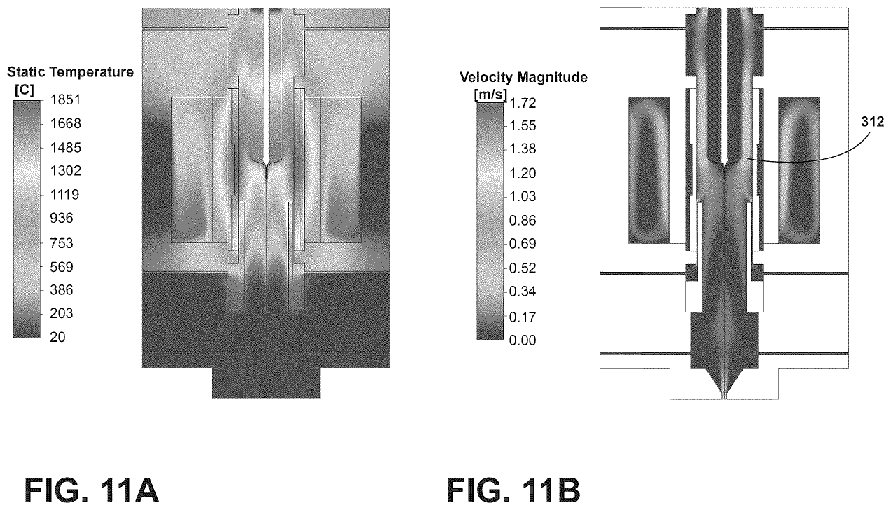

With reference now to FIGS. 9A, 11A, and 11B, the furnace assembly 300 (e.g., the body 304 of the furnace 302) may define one or more cooling liquid channels located proximate the body cavity 305 and configured to circulate a cooling liquid for providing further temperature control within the body cavity 305. For example, the one or more cooling liquid channels may include a lower cooling liquid channel 334 located proximate the hollow-core fiber output port 310, a middle cooling liquid channel 336 located between the middle gas delivery channel 322 and lower cooling liquid channel 334, and an upper cooling liquid channel 338 located proximate the preform input port 308 (e.g., between the upper gas delivery channel 324 and the middle gas delivery channel 322). In some implementations, each cooling channel may be operably coupled to a cooling circulation module 340 (e.g., a different cooling circulation module 340 for each cooling channel). Each cooling circulation module 340 may be configured to independently set a flow rate of the cooling liquid within each of the cooling channels. For example, the cooling circulation module 340 associated with the lower cooling liquid channel 334 may be configured to, and generate a first cooling liquid circulation rate. The cooling circulation module 340 associated with the middle cooling liquid channel 336 may, likewise, be configured to, and generate, a second cooling liquid circulation rate. Further, the cooling circulation module 340 associated with the upper cooling liquid channel 338 may, likewise, be configured to, and generate, a third cooling liquid circulation rate. In some implementations, the first and second rates may be greater than the third rate, such that the temperature (e.g., of an interior surface defining the body cavity 305) proximate the preform input port 308 is elevated and stable. The first and second rates may be greater than the third rate by a factor of 2 or more, for example, a factor of 3 or more, a factor of 5 or more, a factor of 7 or more, a factor of 9 or more, or a factor of 10 or more. In some alternative implementations, the rate of the cooling liquid in the upper liquid channel 338 may be zero or close to zero.

The cooling channels and flow scheme, reduces temperature instability and recirculation of the process gas 312 near an upper section of the furnace 302 (e.g., above the heating element 314). More particularly, one source of instability occurs near the upper section of the furnace 302 where the hollow-core optical fiber preform 200 is exposed to colder process gas 312 purged through the preform input port 308, which results in the colder wall 311 defining the body cavity 305. As the process gas enters the body cavity 305 it heats up and develops a temperature gradient between the wall 311 defining the body cavity 305 and the hollow-core optical fiber preform 200 (e.g., an outer surface thereof). The temperature gradient coupled with the hotter process gas 312 coming from necking region 216 can lead to recirculation in the upper section of the furnace 302 and can create unsteady flow of the process gas 312 and temperature distribution. By reducing the flow rate in the upper cooling liquid channel 338, these issues can be mitigated. Further, in some implementations, the temperature of the process gas 312 entering the upper gas delivery channel 324 may be increased (e.g., from the other delivery channels via a separate heating element). In this manner, the overall temperature of the wall 311 defining the body cavity 305 will increase and the temperature gradients are reduced on the process gas 312 form the furnace wall 311 to an outer surface of the hollow-core optical fiber preform 200. By controlling the rate of the cooling liquid and/or a temperature near the upper section of the furnace 302, the process can be optimized to create a steady state or near steady state at the upper section of the furnace 302. FIGS. 11A and 11B show an embodiment with no cooling in the upper cooling channel 338 from upper section of furnace 302. Reduced colling in the upper section of the furnace 302 results in more uniform temperatures and less circulation of the process gas 312 in the flow field.

With reference to FIGS. 10A-11B, while the static heat maps in FIGS. 10A and 11A of temperature distribution inside the furnace 302, and the process gas velocity magnitude maps in FIGS. 10B and 11B each depict benefits associated with maintaining the ratio of the process gas 312 (FIGS. 10A and 10B) and controlling the flow of cooling liquid (FIGS. 11A and 11B), it should be appreciated that both maintaining the ratio of the process gas 312 and controlling the flow of cooling liquid can be used in conjunction for further benefits.

With reference now back to FIGS. 9A-9C, the furnace assembly 300 may include an upper muffle 342 coupled to the body 304 of the furnace 302 and defining an upper muffle cavity 344 extending along the longitudinal axis 306. A secondary heating element 346 may be located proximate the upper muffle 342 and extend generally along (e.g., and around) the longitudinal axis 306 a distance sufficient to heat the hollow-core optical fiber preform 200 to a uniform temperature prior to the hollow-core optical fiber preform 200 entering the preform input port 308. More particularly, the secondary heating element 346 and the upper muffle 342 may extend a distance of at least 5 cm, for example, at least 10 cm, at least 15 cm, at least 20 cm, at least 25 cm, at least 30 cm, at least 40 cm, at least 50 cm, at least 60 cm, at least 70 cm, at least 80 cm, at least 90 cm, or at least 1 m. In some implementations, the distance may be substantially equal to a length of the hollow-core optical fiber preform 200.

For ensuring uniformity of the capillary elements 210 from the hollow-core optical fiber preform 200 to the hollow-core optical fiber 250, the expansion of the capillary elements 210 depends on the following expression:

$${T}_{furnace} / {T}_{blank}$$

where, T_{furnace} is a temperature of the furnace 302 (e.g., the body cavity 305 or wall 311 thereof) and T_{blank} is the temperature of a top side (e.g., a portion outside of the furnace 302) of the hollow-core optical fiber preform 200. In operation, the hollow-core optical fiber preform 200 is fed into the body cavity 305 and its temperature changes as the hollow-core optical fiber preform 200 is heated and drawn into the hollow-core optical fiber 250. This can result in an axial variation in the radius and thickness of the capillary elements 210 along the length of hollow-core optical fiber 250, which results in an attenuation penalty. To reduce or eliminate the non-uniformity in the dimensions of the capillary elements 210, the secondary heating element 346 heats and maintains the hollow-core optical fiber preform 200 to the uniform temperature. In some implementations, the uniform glass temperature is less than the draw temperature and over about 50% of the draw temperature. To avoid temperature fluctuations due to unstable natural convection, the furnace 302 is heated to sufficiently high temperature to increase the process gas kinematic viscosity and keep the Grashof number of the process gas sufficiently low to prevent unstable flow of the process gas. More particularly, the draw temperature may be between about 1700° C. and about 1900° C. and the uniform temperature of the hollow-core optical fiber preform 200 in the upper muffle cavity 344 may be between about 500° C. and about 1500° C., for example, between about 500° C. and about 1100° C., between about 700° C. and about 1100° C., or between about 800° C. and about 1000° C.

With reference still to FIGS. 9A-9C, the furnace assembly 300 may further include a small diameter tube 348 coupled to the hollow-core fiber output port 310. The small diameter tube 348 may generally extend along the longitudinal axis 306 such that the hollow-core optical fiber 250 exits the furnace 302 (e.g., the hollow-core fiber output port 310) into the small diameter tube 348. In some implementations, the small diameter tube 348 defines an inner radius of between about ½ cm to about 3 cm, for example, between about 0.635 cm to about 2.54 cm. In some implementations, a cooling element 350 may be located proximate the small diameter tube 348. For example, the cooling element 350 may include a channel that introduces a cooling medium (e.g., gas or liquid) into the small diameter tube 348 and cools the hollow-core optical fiber 250 directly or a jacket that cools the small diameter tube 348 directly.

As the hollow-core optical fiber 250 exits the hollow-core fiber output port 310 and extends beyond the furnace 302, air flow around the hollow-core optical fiber 250 can be at temperatures above the forming point as a result of the process gas 312 being purged through the hollow-core fiber output port 310. The residual heating can cause fluctuation in both the hollow-core optical fiber 250 diameter and the diameter of the capillary elements 210. The small diameter tube 348 and cooling element 350 stabilizes convection to the hollow-core optical fiber 250 exiting the furnace 302. Further, the Grashof number to the process gas 312 in the small diameter tube 348 can be further reduced by reducing the characteristic length, L_{c}, in the numerator of the Grashof number definition above by cooling the hollow-core optical fiber 250 quickly and thus increasing stability and reducing perturbations in the fiber microstructure.

As best depicted in FIG. 9A, the furnace assembly 300 may further include a secondary cooling element 352 used in conjunction with or alternatively to the cooling element 350. For example, the secondary cooling element 352 may include at least one air wipe, at least one air knife, and/or at least one flow tube located proximate an end of the small diameter tube 348 opposite the furnace 302 for further temperature control and stability. More particularly, if the hollow-core optical fiber 250 exits the furnace 302 (e.g., without the small diameter tube 348) or the small diameter tube 348 (e.g., when the furnace 302 includes the small diameter tube 348) without reaching its forming point, unsteady natural convection in the ambient space can affect the hollow-core optical fiber 250 250 diameter as well as the capillary element 210 properties. In this case, forced convection is used to overpower natural convection and create a consistent flow around the fiber. Forced convection can be achieved by means of air wipes, air knives or flow tubes surrounding the hollow-core optical fiber 250.

With reference now to FIG. 12, a flow chart illustrating a method 400 of utilizing a furnace assembly in manufacturing a hollow-core optical fiber from a hollow-core optical fiber preform is depicted. The method 400 may include utilizing a furnace assembly including and/or a furnace having a body defining a body cavity extending along a longitudinal axis between a preform input port and a hollow-core fiber output port. The furnace may further include a primary heating element, and a middle gas delivery channel proximate the primary heating element. The method 400 may, for example, be utilized with the furnace assembly 300 and/or the furnace 302 to manufacture a hollow-core optical fiber, such as those depicted in FIGS. 1-7, or, more generally, the hollow-core optical fiber 250, from the hollow-core optical fiber preform depicted in FIG. 8. As such, where terminology is consistent between the method 400 and the description related to FIGS. 1-11B, it should be appreciated that the method 400 may incorporate all the same details, such as components, structures, operational guidelines (e.g., heating temperatures, rates of liquids and gases, etc.), and expressions described previously.

The method 400 may include, at step 402, defining a sleeve gap of the middle gas delivery channel. For example, the sleeve gap may be determined based on the expressions previously discussed. The method 400 may further include, at step 404, introducing process gas via at least the middle gas delivery channel at a delivery flow rate (e.g., delivery volumetric flow rate) for distribution of the process gas through middle gas delivery channel (e.g., the sleeve gap) which directs the process gas to the heat zone 319. The method 400 may further include, at step 406, regulating the delivery volumetric flow rate and a purging volumetric flow rate from the hollow-core fiber output port. A ratio of the delivery volumetric flow rate to the purging volumetric flow rate may be less than 0.6, for example, less than 0.5, less than 0.4, less than 0.3, less than 0.2, or about 0.3. Step 406 may further include maintaining a Reynold number of the process gas in a heat zone 319 between about 1000 and about 2000. The method 400 may further include, at step 408, circulating a cooling liquid in an upper cooling channel proximate the preform input port at a first rate and circulating a cooling liquid in a lower cooling channel proximate the hollow-core fiber output port at a second rate that is greater than the first rate.

In some implementations, the furnace assembly utilized may include an upper muffle coupled to the body of the furnace and defining an upper muffle cavity extending along the longitudinal axis, and a secondary heating element located proximate the upper muffle and extending along the longitudinal axis. In such implementations, the method 400 may further include, at step 410, heating, with the secondary heating element, the hollow-core optical fiber preform to a uniform temperature in the upper muffle cavity. More particularly, step 410 may include heating a necking region of the hollow-core optical fiber preform, with the primary heating element, at a draw temperature, the draw temperature sufficient to soften the necking region, and wherein the uniform temperature is less than the draw temperature and over about 50% of the draw temperature.

The method 400 may more generally include, at each of steps 402-410, introducing or maintaining process gas at a flow in the flow field with an average Grashof number than 1.6×10⁴, or less than 1.4×10⁴, or less than 1.2×10⁴, or less than 1.0×10⁴, or less than 9.0×10³, or between about 7.0×10³ and 1.6×10⁴, or between about 8.0×10³ and 1.4×10⁴, or between about 9.0×10³ and 1.2×10⁴.

While exemplary aspects and examples have been set forth for the purpose of illustration, the foregoing description is not intended in any way to limit the scope of disclosure and appended claims. Accordingly, variations and modifications may be made to the above-described aspects and examples without departing substantially from the spirit and various principles of the disclosure. All such modifications and variations are intended to be included herein within the scope of this disclosure and protected by the following claims.

What is claimed is:

1. A furnace assembly for manufacturing a hollow-core optical fiber from a hollow-core fiber preform comprising:
a furnace including a body defining a body cavity extending along a longitudinal axis between a preform input port and a hollow-core fiber output port; the body cavity configured to locate the hollow-core optical fiber preform and a process gas, the hollow-core optical fiber preform comprising:
a cladding tube having a cladding outer surface and a cladding inner surface, the
cladding inner surface surrounding the longitudinal axis and defining a preform cavity,
and
a plurality of capillary elements attached to the cladding inner surface, each of the
capillary elements having a capillary inner surface defining a capillary cavity,
at least one primary heating element proximate a necking region of the hollow-core optical fiber preform and configured to maintain the necking region at a draw temperature, the draw temperature sufficient to soften the necking region; and
wherein the process gas occupies a flow field surrounding the cladding outer surface, the flow field extending from the necking region to the preform input port, the process gas having a flow with an average Grashof number less than 1.6×10⁴ in the flow field.

2. The furnace assembly of claim 1, wherein the flow of the process gas in the flow field is laminar.

3. The furnace assembly of claim 1, further including an upper muffle coupled to the preform input port of the furnace and defining an upper muffle cavity extending along the longitudinal axis.

4. The furnace assembly of claim 3, further including a secondary heating element located proximate the upper muffle and extending along the longitudinal axis at least 15 cm and configured to sufficiently heat the hollow-core optical fiber preform to a uniform temperature prior to the hollow-core optical fiber preform entering the preform input port.

5. The furnace assembly of claim 4, wherein the uniform temperature is less than the draw temperature and over about 50% of the draw temperature.

6. The furnace assembly of claim 1, wherein the body of the furnace defines a plurality of gas delivery channels for introducing the process gas into the body cavity, including at least a lower gas delivery channel located proximate the hollow-core fiber output port and a middle gas delivery channel located proximate the at least one primary heating element.

7. The furnace assembly of claim 6, wherein a process gas source is configured to introduce the process gas into the lower gas delivery channel at a first delivery volumetric flow rate and introduce the process gas into the middle gas delivery channel at a second delivery volumetric flow rate, wherein the first delivery volumetric flow rate is less than the second delivery volumetric flow rate.

8. The furnace assembly of claim 7, wherein the middle gas delivery channel is configured to direct the process gas toward the necking region.

9. The furnace assembly of claim 1, wherein the body of the furnace defines a plurality of cooling channels configured to circulate a cooling liquid proximate the body cavity, the plurality of cooling channels including an upper cooling channel proximate the preform input port and a lower cooling channel proximate the hollow-core fiber output port,
wherein the upper cooling channel is coupled to an upper cooling circulation module configured to circulate the cooling liquid at a first rate and the lower cooling channel is coupled to a lower cooling circulation module configured to circulate the cooling liquid at a second rate that is greater than the first rate.

10. The furnace assembly according to claim 1, wherein a cooling element is located outside of the body cavity and proximate the hollow-core fiber output port.

11. The furnace assembly according to claim 1, further comprising:
at least one gas delivery channel, the at least one gas delivery channel configured to supply the process gas to the body cavity; and
a process gas source configured to deliver the process gas into the at least one gas delivery channel at a delivery a volumetric flow rate, wherein a ratio of the delivery a volumetric flow rate to a purging volumetric flow rate from the hollow-core fiber output port is less than 0.3.

12. The furnace assembly according to claim 1, wherein the average Grashof number of the process gas in the flow field is less than 1.2×10⁴.

13. A method of utilizing a furnace assembly in manufacturing a hollow-core optical fiber from a hollow-core optical fiber preform, the furnace assembly including a furnace having a body defining a body cavity extending along a longitudinal axis between a preform input port and a hollow-core fiber output port, the furnace further including a primary heating element, and a middle gas delivery channel proximate the primary heating element, the method comprising:
defining a sleeve gap of the middle gas delivery channel, the sleeve gap corresponding to the width of the middle gas delivery channel;
introducing process gas via at least the middle gas delivery channel to a heat zone through the sleeve gap at a volumetric flow rate Q_{hzfr}; and
regulating the delivery volumetric flow rate Q_{hzfr} and a purging volumetric flow rate Q_{bpfr} of a purging gas from the hollow-core fiber output port, wherein a ratio of the delivery volumetric flow rate Q_{hzfr} to the purging volumetric flow rate Q_{bpfr} is less than 0.4.

14. The method according to claim 13, further including regulating the ratio of the delivery volumetric flow rate Q_{hzfr} to the purging volumetric flow rate Q_{bpfr} to less than 0.3.

15. The method according to claim 14, wherein the delivery volumetric flow rate Q_{hzfr} and the purging volumetric flow rate Q_{bpfr} satisfy the condition:
$$\frac{{Q}_{bpfr}}{{r}_{funace}} * \frac{2 * sleeve gap}{{Q}_{hzfr}} < 0.3 .$$
where r_{furnace} is the radius of the body cavity.

16. The method according to claim 13, further including maintaining the Reynold number of the process gas in the heat zone between about 1000 and about 2000, defined by:
$$1000 < R e = \frac{{\dot{m}}_{hzfr}}{2 * {r}_{furnace} * sleeve gap * μ} < 2000$$
where \dot{m}_{hzfr} is a mass flow rate of the process gas from the middle gas delivery channel and μ is the dynamic viscosity of the process gas in the heat zone.

17. The method according to claim 13, further including circulating a cooling liquid in an upper cooling channel proximate the preform input port at a first rate and circulating a cooling liquid in a lower cooling channel proximate the hollow-core fiber output port at a second rate that is greater than the first rate.

18. The method of claim 13, wherein the furnace assembly further includes an upper muffle coupled to the preform input port of the furnace and defining an upper muffle cavity extending along the longitudinal axis, and a secondary heating element located proximate the upper muffle and extending along the longitudinal axis, the method further comprising:
heating, with the secondary heating element, the hollow-core optical fiber preform to a uniform temperature in the upper muffle cavity.

19. The method of claim 18, further including heating a necking region of the hollow-core optical fiber preform in the heat zone, with the primary heating element, at a draw temperature, the draw temperature sufficient to soften the necking region, and wherein the uniform temperature is less than the draw temperature and over about 50% of the draw temperature.

20. The method of claim 13, further including introducing a process gas through at least the middle gas delivery channel, the process gas being introduced at a flow with an average Grashof number less than 1.6×10⁴ in the flow field.
